(19) United States
(12) Patent Application Publication
(10) Pub. No.: US 2008/0077822 A1
(43) Pub. Date: Mar. 27, 2008

(54) INFORMATION PROCESSING APPARATUS AND DISK DRIVE CONTROL METHOD

(75) Inventors: Terunobu Hara, Ome-shi (JP); Toshikazu Morisawa, Tokorozawa-shi (JP); Ken Hatano, Hamura-shi (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 11/858,038

(22) Filed: Sep. 19, 2007

(30) Foreign Application Priority Data
Sep. 22, 2006 (JP) 2006-257755

(51) Int. Cl. G06F 11/00

(52) U.S. Cl. 714/25

(57) ABSTRACT

According to one embodiment, an information processing apparatus that includes a processor and a disk drive, in which the disk drive includes a disk storage medium and a nonvolatile memory device, and is configured to execute a self-diagnosis function and stores diagnosis information obtained by the self-diagnosis function, in the nonvolatile memory device. When the disk drive receives a diagnosis information read-out request from the processor, the disk drive reads out the diagnosis information form the nonvolatile memory device to send the diagnosis information to the processor.

### CROSS-REFERENCE TO RELATED APPLICATIONS

This application is based upon and claims the benefit of priority from Japanese Patent Application No. 2006-257755, filed Sep. 22, 2006, the entire contents of which are incorporated herein by reference.

### BACKGROUND

1. Field

One embodiment of the present invention relates to an information processing apparatus, such as a personal computer, which includes a disk drive having, e.g. a self-diagnosis function.

2. Description of the Related Art

In general, in an information processing apparatus such as a personal computer, a hard disk drive is used as a storage device. The hard disk drive is a disk drive which stores data in a disk storage medium called “hard disk”.

Jpn. Pat. Appln. KOKAI Publication No. 2005-267799 discloses an apparatus having a function of predicting occurrence of a fault of a hard disk drive. In this apparatus, the information, which is indicative of the operation time of the hard disk drive, the number of times of occurrence of power failure during the operation of the hard disk drive, the number of times of suffering of vibration, etc., is stored in a nonvolatile memory unit which is provided outside the hard disk drive. The information stored in the nonvolatile memory unit is used in order to predict the occurrence of a fault of the hard disk drive.

In the meantime, in usual cases, the hard disk drive has a self-diagnosis function called “Self-Monitoring Analysis And Reporting Technology (SMART)”. Diagnosis information (S.M.A.R.T. information), which is obtained by the self-diagnosis function, is stored in the hard disk.

The hard disk drive includes a cache memory. User data is handled as cacheable data, and the user data that has been read out of the hard disk is read out to the system and is also stored in the cache memory. On the other hand, the diagnosis information (S.M.A.R.T. information) is non-cacheable data and is not stored in the cache memory. The system needs to read out the diagnosis information (S.M.A.R.T. information) that is stored in the hard disk, by using a dedicated command.

In most of software programs that monitor the condition of the hard disk drive by using the diagnosis information (S.M.A.R.T. information), the diagnosis information (S.M.A.R.T. information) is always read out from the hard disk drive at regular intervals, and a fault of the hard disk drive is predicted on the basis of the read-out diagnosis information (S.M.A.R.T. information).

However, since the hard disk drive is frequently accessed in order to read out diagnosis information (S.M.A.R.T. information), the power consumption of the hard disk drive increases.

It is necessary, therefore, to realize a novel function for acquiring diagnosis information from a hard disk drive, without incurring an increase in power consumption of the hard disk drive.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing an external appearance of an information processing apparatus according to an embodiment of the invention;

FIG. 2 is an exemplary block diagram showing a system configuration of the information processing apparatus shown in FIG. 1;

FIG. 3 is an exemplary block diagram showing an example of the structure of a disk drive which is provided in the information processing apparatus shown in FIG. 1;

FIG. 4 illustrates a scheme in which SMART information is selectively stored in a nonvolatile memory and a hard disk which are provided in the disk drive shown in FIG. 3;

FIG. 5 is an exemplary block diagram showing the functional structure of a BIOS which is used in the information processing apparatus shown in FIG. 1;

FIG. 6 shows an example of a setup screen which is displayed by the BIOS illustrated in FIG. 5;

FIG. 7 is an exemplary flowchart illustrating a part of the procedure of diagnosis information storage location designation process which is executed by the information processing apparatus shown in FIG. 1;

FIG. 8 is an exemplary flowchart illustrating the other part of the procedure of the SMART information storage location designation process which is executed by the information processing apparatus shown in FIG. 1;

FIG. 9 is an exemplary flowchart illustrating the procedure of a SMART information read-out process which is executed by the disk drive shown in FIG. 3;

FIG. 10 is an exemplary flowchart illustrating the procedure of a self-diagnosis process which is executed by the disk drive shown in FIG. 3; and

FIG. 11 is an exemplary flowchart illustrating the procedure of an operation mode switching process which is executed by the disk drive shown in FIG. 3.

### DETAILED DESCRIPTION

Various embodiments according to the invention will be described hereinafter with reference to the accompanying drawings. In general, according to one embodiment of the invention, an information processing apparatus includes: a processor; and a disk drive which includes a disk storage medium and a nonvolatile memory device, executes a self-diagnosis function and stores diagnosis information, which is obtained by the self-diagnosis function, in the nonvolatile memory device, the disk drive reading out the diagnosis information from the nonvolatile memory device to send the diagnosis information to the processor when the disk drive receives a diagnosis information read-out request from the processor.

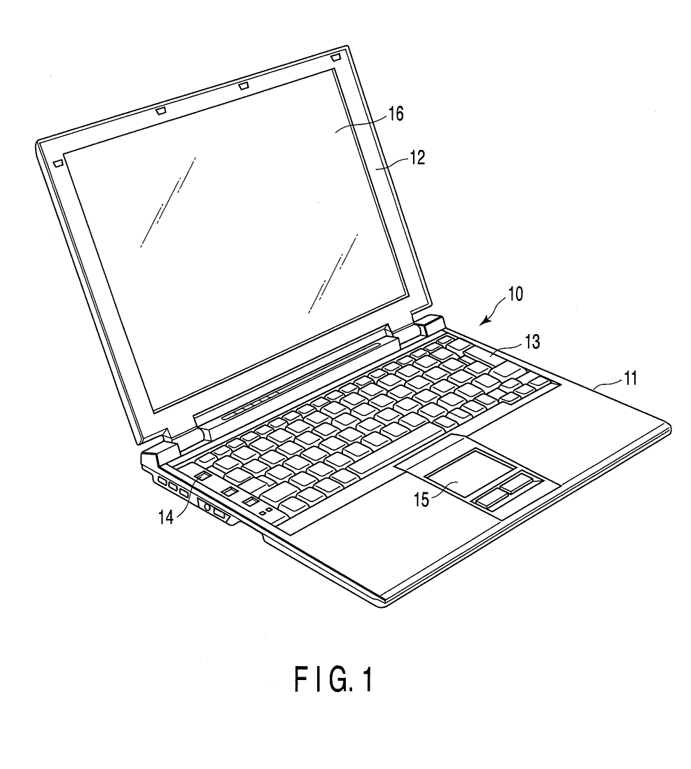

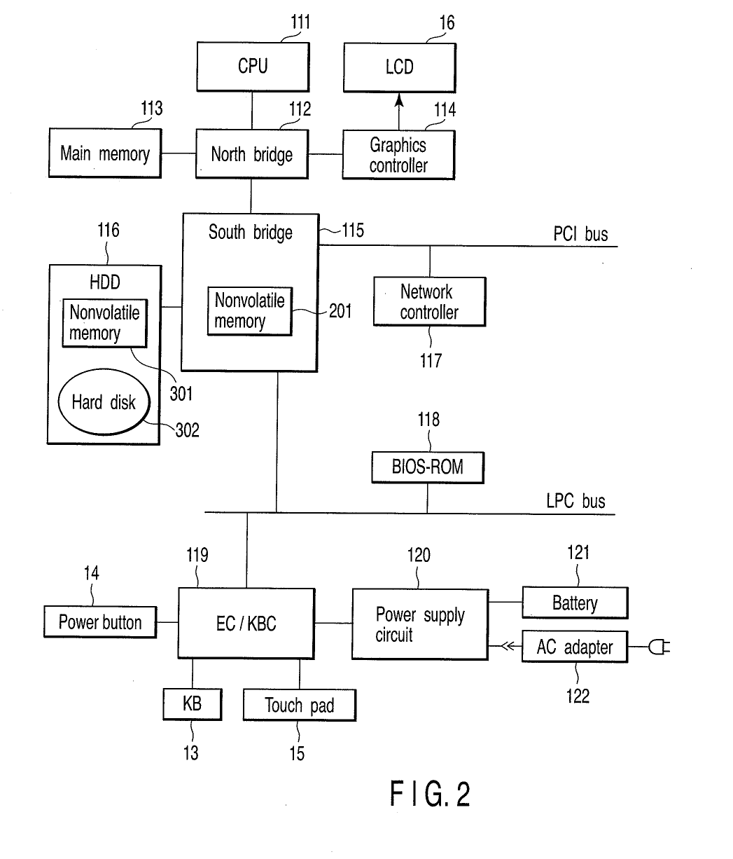

To begin with, referring to FIG. 1 and FIG. 2, the structure of an information processing apparatus according to the embodiment of the invention is described. The information processing apparatus is realized, for example, as a battery-powerable notebook portable personal computer 10.

FIG. 1 is a perspective view showing the computer 10, as viewed from the front side, in the state in which a display unit thereof is opened.

The computer 10 comprises a main body 11 and a display unit 12. A display device that is composed of an LCD (Liquid Crystal Display) 16 is built in the display unit 12. The display screen of the LCD 16 is positioned at an approximately central part of the display unit 12.

The display unit 12 is attached to the main body 11 such that the display unit 12 is freely rotatable between an open position where a top surface of the main body 11 is exposed and a closed position where the top surface of the main body 11 is covered. The main body 11 has a thin box-shaped casing. A keyboard 13, a power switch 14 for powering on/off the computer 10, and a touch pad 15 are disposed on the top surface of the main body 11.

FIG. 2 shows the system configuration of the computer 10.

The computer 10 comprises a CPU 111, a north bridge 112, a main memory 113, a graphics controller 114, a south bridge 115, a hard disk drive (HDD) 116, a network controller 117, a BIOS-ROM 118, an embedded controller/keyboard controller IC (EC/KBC) 119, and a power supply circuit 120.

The CPU 111 is a processor which controls the operations of the components of the computer 10. The CPU 111 executes an operating system and various application programs, which are loaded in the system memory 113 from the HDD 116. The operating system includes HDD diagnosis software for predicting a fault of the HDD 116. The HDD diagnosis software periodically acquires diagnosis information (S.M.A.R.T. information) from the HDD 116, and predicts a fault of the HDD 116 on the basis of the acquired diagnosis information (S.M.A.R.T. information).

The CPU 111 also executes a BIOS (Basic Input/Output System) that is stored in the flash BIOS-ROM 118. The BIOS is a program for hardware control.

The north bridge 112 is a bridge device that connects a local bus of the CPU 111 and the south bridge 115. The north bridge 112 has a function of executing communication with the graphics controller 114 via, e.g. an AGP (Accelerated Graphics Port) bus. Further, the north bridge 112 includes a memory controller that controls the main memory 113.

The graphics controller 114 is a display controller for controlling the LCD 16 that is used as a display monitor of the computer 10. The south bridge 115 is connected to a PCI (Peripheral Component Interconnect) bus and an LPC (Low Pin Count) bus.

The south bridge 115 incorporates a nonvolatile memory 201. The nonvolatile memory 201 stores setup information that is indicative of an operational environment of the computer 10.

The HDD 116 is a disk drive called “hybrid disk drive”, and includes a nonvolatile memory device 301 and a hard disk 302 as storage media. The nonvolatile memory device 301 is composed of, e.g. a NAND-type flash EEPROM. The hard disk 302 is a disk storage medium that magnetically stores data. The data write to the hard disk (disk storage medium) 302 and data read from the hard disk 302 are executed by using a mechanical driving mechanism which is provided in the HDD 116. This driving mechanism includes a spindle motor which rotates the hard disk 302, a head for data write and data read, and an actuator for moving the head.

In a case where data (user file, system file, etc.) which is designated by a read request from the CPU 111 is present in the nonvolatile memory device 301, access to the hard disk 302 is not executed, and this data is read out from the nonvolatile memory device 301. Thus, necessary data can quickly be read out of the nonvolatile memory device 301, without rotating the hard disk 302.

In the present embodiment, not only ordinary data (user file, system file, etc.) but also diagnosis information (S.M.A.R.T. information) can be stored in the nonvolatile memory device 301.

Specifically, the HDD 116 has a self-diagnosis function that is called “SMART (Self-Monitoring Analysis And Reporting Technology). The HDD 116 can store diagnosis information (S.M.A.R.T. information), which is obtained by executing the self-diagnosis function, in the nonvolatile memory device 301. The diagnosis information (S.M.A.R.T. information) indicates the condition of the HDD 116, in particular, the condition of the hard disk 302, and indicates values corresponding to many check items. The check items include, for instance, “Raw Read Error Rate” (the probability of occurrence of errors at a time of data read from the hard disk 302), “Reallocated Sectors Count” (the number of sectors for which a substitution process has been executed due to sector defects), “Spin Up time” (the time needed from when the rotation of the hard disk 302 is started to when the rotation speed of the hard disk 302 reaches a normal rotation speed), and “Temperature” (the temperature in the HDD 116).

In the description below, the diagnosis information (S.M.A.R.T. information) is referred to simply as “SMART information”.

As described above, the SMART information is stored in the nonvolatile memory device 301. Thus, responding to a diagnosis information read-out request that is sent from the CPU 111, the HDD 116 can quickly read out the SMART information from the nonvolatile memory device 301 and sends it to the CPU 111. In this case, since there is no need to rotate the hard disk 302, the power that is consumed for the read-out of the SMART information can greatly be reduced, compared to the case of reading out the SMART information from the hard disk 302. Furthermore, even if a fault occurs in the hard disk 302 and data read-out from the hard disk 302 is disabled, the SMART information can be read out from the nonvolatile memory device 301 and thus the cause of the occurrence of a fault, for instance, can be examined.

Needless to say, the HDD 116 may store the SMART information in the hard disk 302.

The storage medium in which the SMART information is to be stored is designated by a command which is sent from the CPU 111 to the HDD 116. Specifically, the HDD 116 is configured to switch the medium, in which the SMART information is to be stored, between the nonvolatile memory device 301 and hard disk 302 in accordance with the command from the CPU 111. The command designates the medium in which the SMART information is to be stored.

Since the number of times of data rewrite in the nonvolatile memory device 301 is limited, the structure that switches the medium, in which the SMART information is to be stored, between the nonvolatile memory device 301 and hard disk 302 can contribute to increasing the lifetime of the nonvolatile memory device 301.

The embedded controller/keyboard controller IC (EC/KBC) 119 is a 1-chip microcomputer in which an embedded controller for power management and a keyboard controller for controlling the keyboard (KB) 13 and touch pad 15 are integrated. The EC/KBC 119 cooperates with the power supply circuit 120 to power on/off the computer 10 in response to the user's operation of the power button switch 14. The power supply circuit 120 uses power from a battery 121 which is built in the computer main body 11 or external power which is supplied via an AC adapter 122, thereby generating system power that is to be supplied to the respective components of the computer 10.

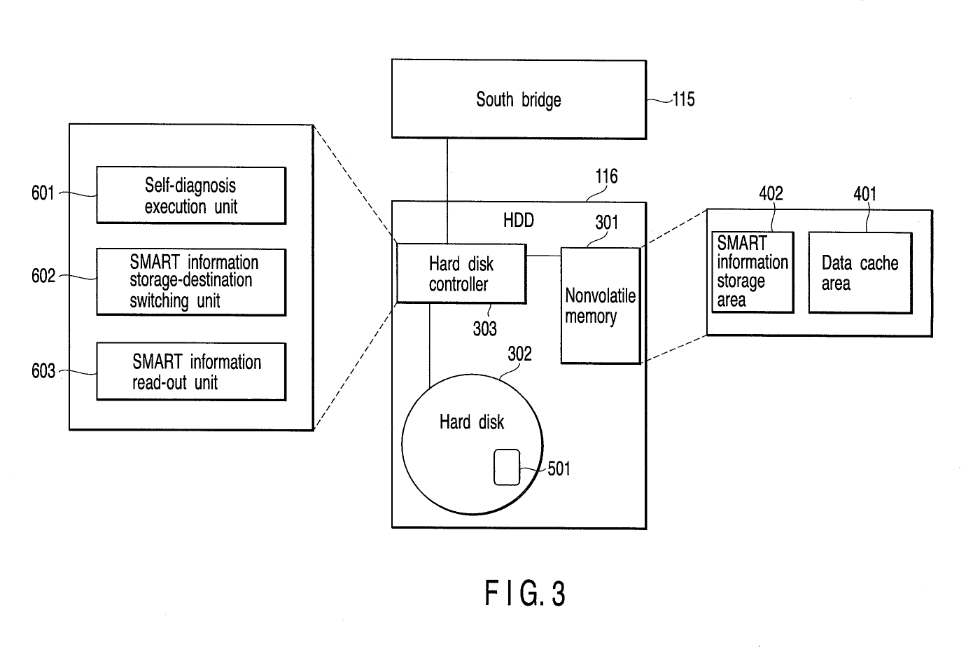

Next, referring to FIG. 3, an example of the structure of the HDD 116 is described.

The HDD 116 includes a hard disk controller 303 in addition to the above-described nonvolatile memory 301 and hard disk 302. The hard disk controller 303 is a controller for accessing the nonvolatile memory 301 and hard disk 302. The hard disk controller 303 can selectively access the nonvolatile memory 301 and hard disk 302 in response to an access request which is delivered from the CPU 111 via, e.g. an ATA (AT Attachment) controller that is provided in the south bridge 115.

A data cache area 401 and a SMART information storage area 402 are defined in the memory area of the nonvolatile memory 301.

The data cache area 401 is a memory area which temporarily stores data that has been read out of the hard disk 302 and data that is to be written in the hard disk 302. When the hard disk controller 303 has received a read request from the CPU 111, the hard disk controller 303 determines whether the data that is designated by the read request from the CPU 111 is present in the data cache area 401 or not. If the data designated by the read request is present in the data cache area 401, the hard disk controller 303 reads out the data designated by the read request from the data cache area 401. During the time period in which there is no need to access the hard disk 302, the hard disk controller 303 keeps the hard disk 302 in the rotation halt state. Only when there is a need to access the hard disk 302, the hard disk controller 303 spins up the hard disk 302 and executes access to the hard disk 302. After the access to the hard disk 302 is completed, the hard disk controller 303 stops rotation of the hard disk 302.

The SMART information storage area 402 is a memory area for storing the SMART information.

A smart information storage area 501, which is a memory area for storing the SMART information, is also defined in the storage area of the hard disk 302.

The hard disk controller 303 includes, as functional units for handling the SMART information, a self-diagnosis function execution unit 601, a SMART information storage-destination switching unit 602 and a SMART information read-out unit 603.

The self-diagnosis function execution unit 601 is a unit configured to execute the above-described self-diagnosis function. The self-diagnosis function is executed, for example, when access to the hard disk 302 is executed. Needless to say, the self-diagnosis function may periodically be executed according to a predetermined schedule.

The SMART information storage-destination switching unit 602 is a unit configured to switch the medium, in which the SMART information obtained by the self-diagnosis by the self-diagnosis function execution unit 601 is to be stored, between the nonvolatile memory 301 and hard disk 302. The SMART information storage-destination switching unit 602 has a function of storing the SMART information in one of the nonvolatile memory 301 and hard disk 302, which is designated by a command that is sent to the HDD 116 from the CPU 111.

Specifically, the SMART information storage-destination switching unit 602 has two operation modes, that is, a first mode and a second mode, as operation modes for storing the SMART information in the storage medium. In accordance with a command from the CPU 111, the SMART information storage-destination switching unit 602 operates in one of the first mode and second mode. The first mode is a mode in which the SMART information storage-destination switching unit 602 stores the SMART information, which is obtained by the self-diagnosis, in the SMART information storage area 501 of the hard disk 302. The second mode is a mode in which the SMART information storage-destination switching unit 602 stores the SMART information, which is obtained by the self-diagnosis, in the SMART information storage area 402 of the nonvolatile memory 301.

In the case where the first mode is designated by the command from the CPU 111, the SMART information switching unit 602 operates in the first mode and stores the SMART information in the SMART information storage area 501 of the hard disk 302. In the case where the second mode is designated by the command from the CPU 111, the SMART information switching unit 602 operates in the second mode and stores the SMART information in the SMART information storage area 402 of the nonvolatile memory 301.

The SMART information switching unit 602 also has a function of automatically transitioning the operation mode from the first mode to the second mode. The transition from the first mode to the second mode is executed when an access error ratio of access to the hard disk 302 has exceeded a predetermined value. The access error ratio is indicative of a ratio of error occurrence of the hard disk 302. For example, the access error ratio can be determined from values of, e.g. “Raw Read Error Rate” and “Reallocated Sectors Count” of the SMART information.

In the case where the HDD diagnosis software is being executed, the CPU 111 periodically sends a SMART information read-out request to the HDD 116 under the control of the HDD diagnosis software. Responding to the SMART information read-out request from the CPU 111, the SMART information read-out unit 603 determines whether the SMART information is stored in the nonvolatile memory 301 or the hard disk 302. The SMART information read-out request is a dedicated command for requesting read-out of the SMART information from the HDD 116. In the case where the SMART information is stored in the nonvolatile memory 301, the SMART information read-out unit 603 reads out the SMART information from the nonvolatile memory 301, thereby to transmit the smart information to the CPU 111. On the other hand, in the case where the SMART information is stored in the hard disk 302, the SMART information read-out unit 603 reads out the SMART information from the hard disk 302, thereby to transmit the smart information to the CPU 111.

As described above, the SMART information read-out unit 603 identifies the medium which is currently used for storing the SMART information, and reads out the SMART information from the identified medium. Thus, the HDD diagnosis software does not need to take care of whether the SMART information is stored in the nonvolatile memory 301 or the hard disk 302.

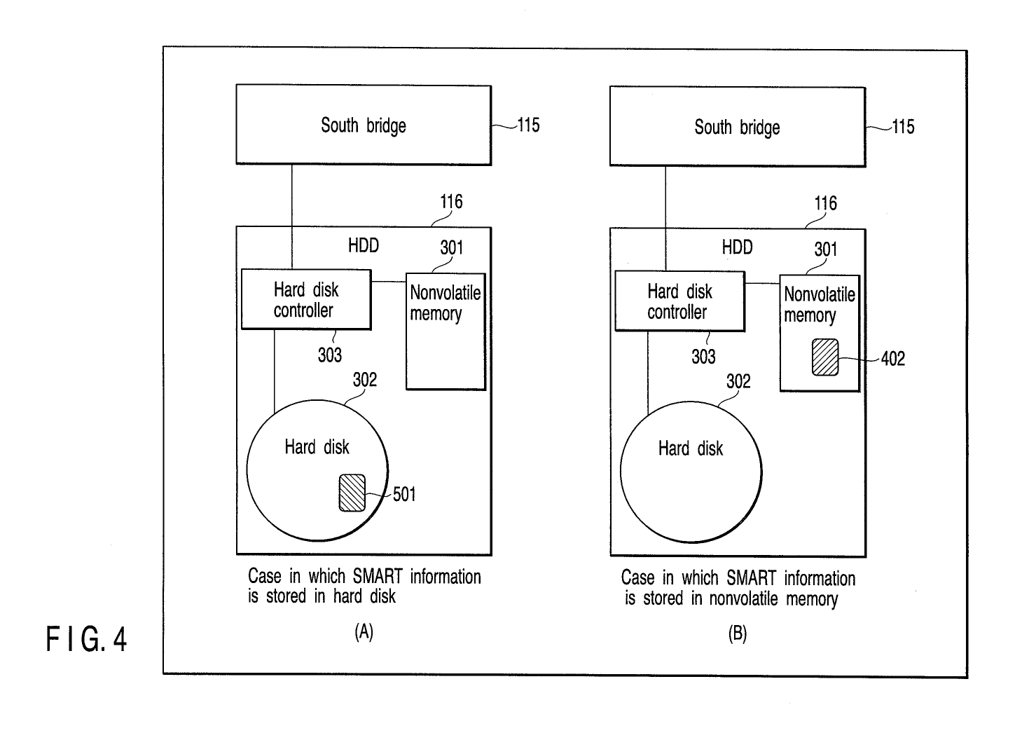

FIG. 4 shows destinations of storage of SMART information in the first mode and second mode.

In the first mode, as shown in part (A) of FIG. 4, the SMART information is written in the SMART information storage area 501 of the hard disk 302 each time the self-diagnosis function is executed, and the SMART information is not written in the nonvolatile memory 301. On the other hand, in the second mode, as shown in part (B) of FIG. 4, the SMART information is written in the SMART information storage area 402 of the nonvolatile memory 301, and the SMART information is not written in the hard disk 302.

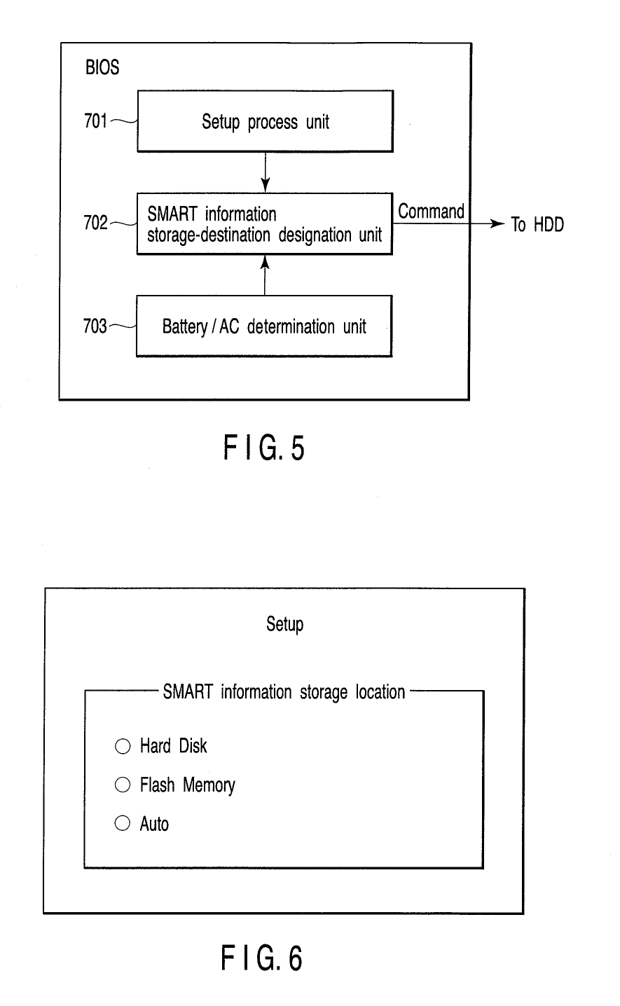

Next, referring to FIG. 5, the functional structure of the BIOS is described.

The function of designating the medium, in which the SMART information is to be stored, to the HDD 116 is realized by the BIOS. The BIOS includes, as its functional structure modules, a setup process unit 701, a SMART information storage-destination designation unit 702, and a battery/AC discrimination unit 703. The setup process unit 701, SMART information storage-destination designation unit 702 and battery/AC discrimination unit 703 are software modules which are executed by the CPU 111.

The setup process unit 701 displays on the display screen of the LCD 16 a setup screen for prompting the user to designate the operational environment of the computer 10. As shown in FIG. 6, the setup screen includes a setup item for prompting the user to designate the location of storage of SMART information. This setup item is used in order to prompt the user to select one of three modes, i.e. a “Hard Disk” mode, a “Flash Memory” mode and an “Auto” mode. The “Hard Disk” mode is a mode in which the SMART information is stored in the hard disk 302. The “Flash Memory” mode is a mode in which the SMART information is stored in the nonvolatile memory 301. The “Auto” mode is a mode in which the medium, in which the SMART information is to be stored, is switched between the hard disk 302 and nonvolatile memory 301 in accordance with the type of power supply (battery/external power supply) for driving the computer 10. Information (SMART information storage-destination designation information) that is indicative of the mode (“Hard Disk” mode, “Flash Memory” mode or “Auto” mode) selected by the user is stored, together with the information that designates other operational environments, in the nonvolatile memory 201 in the south bridge 115 by the setup process unit 701.

The SMART information storage-destination designation unit 702 executes, in accordance with the SMART information storage-destination designation information, a process of sending to the HDD 116 a command that designates the medium in which the SMART information is to be stored, that is, a command that designates the operation mode (first mode/second mode) of the HDD 116.

For example, if the SMART information storage-destination designation information indicates the “Hard Disk” mode, the command that designates the first mode, i.e. the command that designates the hard disk 302 as the location of storage of SMART information, is sent to the HDD 116. If the SMART information storage-destination designation information indicates the “Flash Memory” mode, the command that designates the second mode, i.e. the command that designates the nonvolatile memory 301 as the location of storage of SMART information, is sent to the HDD 116. If the SMART information storage-destination designation information indicates the “Auto” mode, the battery/AC discrimination unit 703 discriminates whether the computer 10 is driven by the battery 121 or the external power supply (power from the AC adapter 122). Based on the discrimination result, the command that designates the first mode or second mode is sent to the HDD 116.

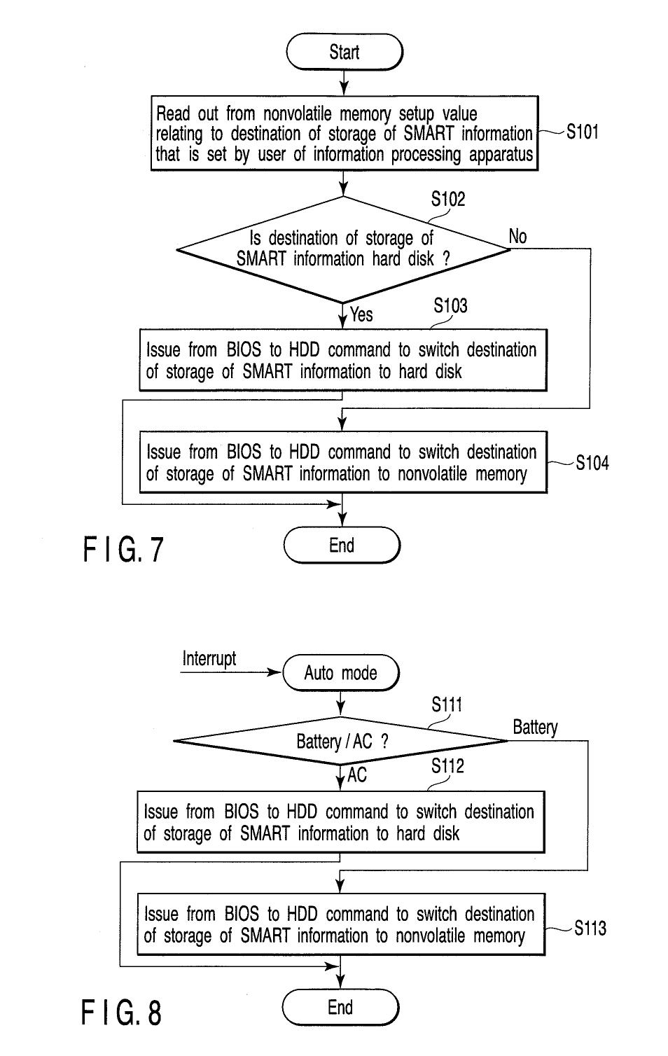

Next, referring to flowcharts of FIG. 7 and FIG. 8, a description is given of the procedure of a SMART information storage location designation process which is executed by the BIOS.

When the computer 10 is powered on, the CPU 111 first executes the BIOS. The BIOS executes a POST (Power-On Self Test) process for initializing the respective components. In the POST process, the BIOS executes the SMART information storage location designation process that is described below.

To start with, the BIOS reads out from the nonvolatile memory 201 the setup value relating to the destination of storage of SMART information, which has been set by the user (block S101). In block 101, the above-described SMART information storage-destination designation information is read out of the nonvolatile memory 201.

Based on the SMART information storage-destination designation information, the BIOS determines whether the destination of storage of SMART information is the hard disk 302 or not (block S102). In block S102, the BIOS determines which of the “Hard Disk” mode, “Flash Memory” mode and “Auto” mode is indicated by the SMART information storage-destination designation information.

If the SMART information storage-destination designation information indicates the “Hard Disk” mode, the BIOS determines that the destination of storage of SMART information is the hard disk 302 (YES in block S102). In this case, the BIOS executes a process of issuing a command that switches the destination of storage of SMART information to the hard disk 302, that is, a command that designates the first mode (block S103). The command that designates the first mode is sent from the CPU 111 to the HDD 116 via, e.g. an ATA (AT Attachment) controller which is provided in the south bridge 115.

If the SMART information storage-destination designation information indicates the “Flash Memory” mode, the BIOS determines that the destination of storage of SMART information is not the hard disk 302 but the nonvolatile memory 301 (NO in block S102). In this case, the BIOS executes a process of issuing a command that switches the destination of storage of SMART information to the nonvolatile memory 301, that is, a command that designates the second mode (block S104). The command that designates the second mode is sent from the CPU 111 to the HDD 116 via, e.g. the ATA (AT Attachment) controller provided in the south bridge 115.

If the SMART information storage-destination designation information indicates the “Auto” mode, the BIOS executes the procedure illustrated in the flowchart of FIG. 8.

Specifically, the BIOS cooperates with the EC/KBC 119 to determine whether the computer 10 is being driven by the battery 121 or the external power supply (AC power supply) (block S111).

If the computer 10 is being driven by the external power supply, the BIOS executes the process of issuing the command that switches the destination of storage of SMART information to the hard disk 302, that is, the command that designates the first mode (block S112). The command that designates the first mode is sent from the CPU 111 to the HDD 116 via, e.g. the ATA (AT Attachment) controller which is provided in the south bridge 115.

On the other hand, if the computer 10 is being driven by the battery 121, the BIOS executes the process of issuing the command that switches the destination of storage of SMART information to the nonvolatile memory 301, that is, the command that designates the second mode (block S113). The command that designates the second mode is sent from the CPU 111 to the HDD 116 via, e.g. the ATA (AT Attachment) controller provided in the south bridge 115.

By the procedure shown in FIG. 8, in the case where the computer 10 is being driven by the external power supply, it is possible to suppress an increase in number of times of rewrite operations of the nonvolatile memory 301, which results from the write of the SMART information. In addition, in the case where the computer 10 is being driven by the battery, the power consumption of the HDD 116 can be reduced and thus the battery driving time can be increased.

The process procedure illustrated in FIG. 8 is executed not only at the time of the POST process but also at the time when the type of the power supply for driving the computer 10 has been changed. For example, the EC/KBC 119 sends an interrupt signal to the CPU 111 when the AC adapter 122 has been attached to the computer 10 and thereby the power supply for driving the computer 10 has been changed from the battery to the external power supply, or when the AC adapter 122 has been detached from the computer 10 and thereby the power supply for driving the computer 10 has been changed from the external power supply to the battery. Responding to the interrupt signal, the process of FIG. 8 by the BIOS is started.

Accordingly, if the user has selected the “Auto” mode, the medium in which the SMART information is to be stored is dynamically switched, even during the operation of the computer 10, between the nonvolatile memory 301 and hard disk 302 in accordance with the change of the type of the power supply for driving the computer 10.

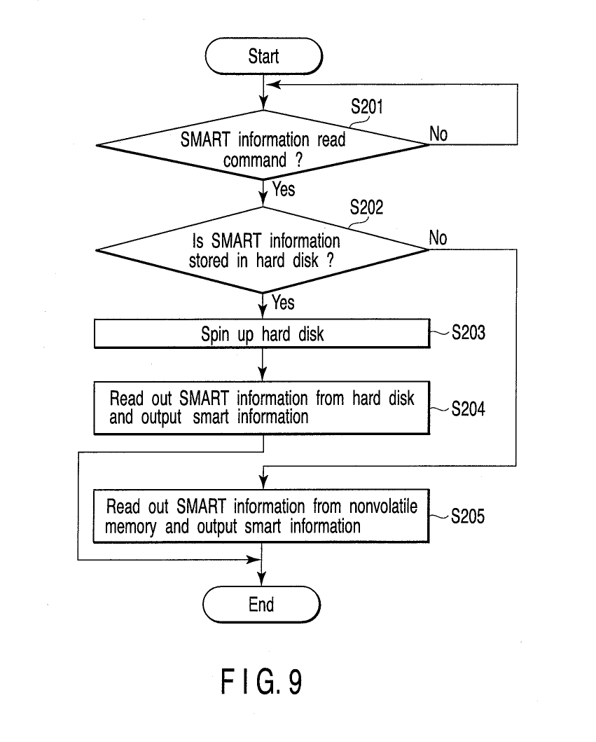

Next, referring to a flowchart of FIG. 9, the procedure of a SMART information read-out process, which is executed by the HDD 116, is described.

If the HDD 116 receives a SMART information read-out request (SMART information read command) that is sent from the CPU 111 (block S201), the HDD 116 determines whether the SMART information is stored in the hard disk 302, that is, whether the medium, which is currently used for storing the SMART information, is the hard disk 302 or not (block S202).

If the medium that is currently used for storing the SMART information is the hard disk 302 (YES in block S202), the HDD 116 controls the spindle motor and spins up the hard disk 302 (block S203), and then reads out the SMART information from the hard disk 302 and sends the SMART information to the CPU 111 (block S204).

If the medium that is currently used for storing the SMART information is not the hard disk 302, that is, if the medium that is currently used for storing the SMART information is the nonvolatile memory 301 (NO in block S202), the HDD 116 reads out the SMART information from the nonvolatile memory 301 and sends the SMART information to the CPU 111 (block S205).

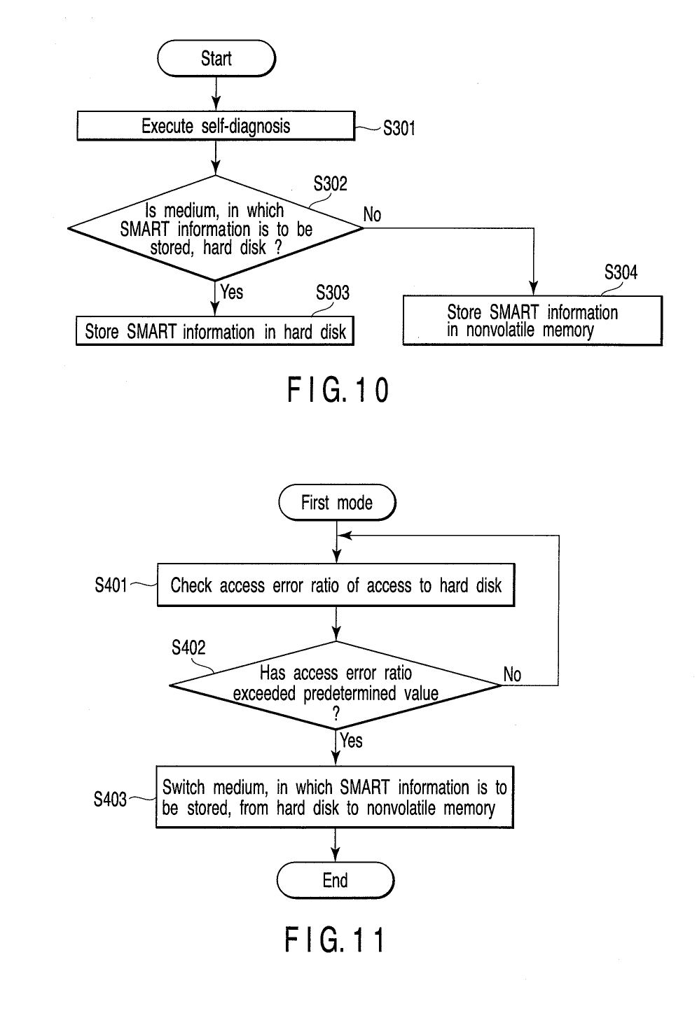

Next, referring to a flowchart of FIG. 10, the procedure of the self-diagnosis, which is executed by the HDD 116, is described.

The HDD 116 executes the self-diagnosis function relating to various check items, and obtains the SMART information including values corresponding to the various check items (block S301). Then, the HDD 116 determines whether the medium, in which the SMART information is to be stored, is the hard disk 302 or not, that is, whether the operation mode that is designated by the CPU 111 (BIOS) is the first mode or not (block S302).

If the operation mode designated by the CPU 111 is the first mode (YES in block S302), the HDD 116 stores the SMART information, which is obtained by the self-diagnosis function, in the hard disk 302 (block S303). On the other hand, if the operation mode designated by the CPU 111 is the second mode (NO in block S302), the HDD 116 stores the SMART information, which is obtained by the self-diagnosis function, in the nonvolatile memory 301 (block S304).

Next, referring to a flowchart of FIG. 11, an operation mode switching process, which is executed by the HDD 116, is described.

When the first mode has been designated by the CPU 111, the HDD 116 operates in the first mode and executes the process of storing the SMART information obtained by the self-diagnosis function in the hard disk 302, and also executes the following process in parallel.

Specifically, the HDD 116 checks the access error ratio of access to the hard disk 302, for example, by using the SMART information obtained by the self-diagnosis function (block S401), and determines whether the access error ratio has exceeded a predetermined value (block S402).

If the access error ratio has exceeded the predetermined value (YES in block S402), the HDD 116 transitions to the second mode and switches the medium in which the SMART information is to be stored, from the hard disk 302 to the nonvolatile memory 301 (block S403).

It is thus possible to switch the medium, in which the SMART information is to be stored, from the hard disk 302 to the nonvolatile memory 301, before a fault occurs in the hard disk 302.

As has been described above, in the present embodiment, use is made of the mode (second mode) in which the smart information is stored in the nonvolatile memory 301. Thereby, the SMART information can be read out without accessing the hard disk 302. Therefore, there is no need to spin up the hard disk 302 each time the SMART information is read out, and the power consumption of the hard disk 302 can greatly be reduced. Moreover, even in the case where the spin-up of the hard disk 302 is disabled due to a fault of the hard disk 302, the SMART information can be read out.

In addition, for example, in the case where there is no need to save power consumption, the mode (first mode), in which the SMART information is stored in the hard disk 302, can be used. Therefore, it is possible to suppress an increase in number of times of rewrite operations of the nonvolatile memory 301, which results from the write of the SMART information. This contributes to elongation of the lifetime of the nonvolatile memory device 301.

Furthermore, when the access error rate of the hard disk 302 has exceeded a predetermined value, the medium, in which the SMART information is to be stored, is switched from the hard disk 302 to the nonvolatile memory 301. Thus, even if a fault occurs in the hard disk 302 in the state in which the hard disk mode is selected, the SMART information can be read out from the nonvolatile memory 301.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a processor; and
a disk drive comprising a disk storage medium and a nonvolatile memory device, wherein the disk drive is configured to execute a self-diagnosis function, to store diagnosis information in the nonvolatile memory device, and to read out the diagnosis information from said nonvolatile memory device to send said diagnosis information to the processor when the disk drive receives a diagnosis information read-out request from the processor.

2. The information processing apparatus according to claim 1, wherein the disk drive is further configured to switch where the diagnosis information is to be stored between the disk storage medium and the nonvolatile memory device in response to a command from the processor to make such switch, and wherein said disk drive in further configured to designate in which medium said diagnosis information is to be stored.

3. The information processing apparatus according to claim 2, wherein the disk drive is further configured to determine whether the diagnosis information is stored in the nonvolatile memory device or in the disk storage medium in response to the diagnosis information read-out request from the processor, and to read out said diagnosis information from either said nonvolatile memory device or said disk storage medium depending upon where such diagnosis information is stored.

4. The information processing apparatus according to claim 1, wherein the disk drive is further configured to operate in one of a first mode in which the diagnosis information is stored in the disk storage medium or a second mode in which the diagnosis information is stored in the nonvolatile memory device, and wherein the processor is configured to send a command that designates the first mode if the information processing apparatus is being driven by an external power supply or the second mode if the information processing apparatus is being driven by a battery.

5. The information processing apparatus according to claim 1, wherein the disk drive is further configured to operate, in response to direction from the processor, in one of a first mode in which the diagnosis information is stored in the disk storage medium or a second mode in which the diagnosis information is stored in the nonvolatile memory device, and wherein the disk drive is further configured to, when operating in the first mode, to determine whether an access error rate of access to said disk storage medium has exceeded a predetermined value and transition from the first mode to the second mode if the access error ratio has exceeded the predetermined value, thereby switching said diagnosis information from the disk storage medium to the nonvolatile memory device.

6. The information processing apparatus according to claim 5, wherein the disk drive is further configured to determine, in response to the diagnosis information read-out request from the processor, whether the diagnosis information is stored in the nonvolatile memory device or in the disc storage medium, and to read out the diagnosis information from where it is stored.

7. An information processing apparatus that may be powered by one of either a battery or an external power supply, the apparatus comprising:
a disk drive that comprises a disk storage medium and a nonvolatile memory device, wherein the disk drive is configured to execute a self-diagnosis function, and to store diagnosis information that is obtained by the self-diagnosis function either the disk storage medium or the nonvolatile memory device;
means for causing a display device to display a prompt that permits a user to select one of either a first mode in which the diagnosis information is stored in the disk storage medium, a second mode in which the diagnosis information is stored in the nonvolatile memory device, or a third mode in said diagnosis information is switched between either the disk storage medium and the nonvolatile memory device or vice versa depending upon the type of a power supply used for powering the information processing apparatus;
means for sending a command that instructs that the diagnosis information be stored in the disk storage medium if the first mode is selected by the user or the nonvolatile memory device if the second mode is selected by the user; and
means for determining whether the information processing apparatus is being powered by the battery or the external power supply if the third mode is selected by the user and for sending a command, that instructs either that the diagnosis information be stored in the disk storage medium if the apparatus is being powered by the external power supply or the nonvolatile memory device if the apparatus is being powered by the battery.

8. A method for controlling a disk drive provided within an information processing apparatus comprising a processor and the disk drive, the apparatus being configured to be powered by one of either a battery or an external power source, the disk drive comprising a disk storage medium and a nonvolatile memory device and configured to execute a self-diagnosis function, the method comprising;
storing diagnosis information obtained by the self-diagnosis function in one of either the disk storage medium or the nonvolatile memory device depending upon a command sent from the processor to the disk drive;
determining whether the diagnosis information is stored in the nonvolatile memory device or in the disk storage medium in response to a diagnosis information read-out request sent from the processor to the disk drive; and
reading out the diagnosis information from either the nonvolatile memory device or the disk storage medium, depending upon where it is stored, and sending the diagnosis information to the processor.

9. The method of claim 8 further comprising:
determining whether the information processing apparatus is being powered by a battery or an external power supply;
causing the processor to send a command to the disk drive, the command either designating the disk storage medium if the information processing apparatus is being powered by the external power supply or the nonvolatile memory device if said apparatus is being powered by the battery.

10. The method of claim 8 further comprising:
determining whether an access error rate of access to the disk storage medium has exceeded a predetermined value if the disk storage medium has been designated by the command from the processor; and
switching the designation to the nonvolatile memory device if the access error ration has exceeded the predetermined value.
